(19) United States
(12) Patent Application Publication
(10) Pub. No.: US 2024/0378524 A1
(43) Pub. Date: Nov. 14, 2024

(54) Systems and Methods for Automatic Resource Forecasting and Optimization

(71) Applicant: ZEBRA TECHNOLOGIES CORPORATION, Lincolnshire, IL (US)

(72) Inventors: Suvarna S. Krishnan, Westwood, MA (US); Sriram Krishnan, Sharon, MA (US)

(21) Appl. No.: 18/195,193

(22) Filed: May 9, 2023

(51) Int. Cl. G06Q 10/0631

(52) U.S. Cl. CPC G06Q 10/06315

(57) ABSTRACT

Systems and methods for automatic resource allocation and optimization. The method receives at least one first data component associated with a user and at least one second data component associated with the user. The system determines at least one first value for a first metric of the user based on the received at least one first data component and determines at least one second value for a second metric of the user based on the received at least one second data component. The system determines at least one third value for a third metric of the user based on the at least one first value of the first metric and the at least one second value of the second metric and utilizes the at least one third value for the third metric in a forecasting mechanism.

### BACKGROUND

An organization (e.g., a retailer, hospitality facility, or other type of enterprise) can utilize a system to forecast an allocation of resources (e.g., labor cost and time) for operational purposes. Often, an organization is restricted to specific data sources and associated attributes (e.g., granularities) thereof to forecast an allocation of these resources. This can be challenging because each organization has unique needs (e.g., data sources and associated attributes) that require evaluation in view of predetermined parameters (e.g., minimums, maximums, etc.) when forecasting an allocation of resources for operational purposes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the system of the present disclosure.

FIG. 2 is a diagram illustrating an embodiment of the system of the present disclosure.

FIG. 3 is a flowchart illustrating processing steps carried out by the system of the present disclosure.

FIG. 4 is a flowchart illustrating step 212 of FIG. 3 in greater detail.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method for automatic resource allocation and optimization, comprising: receiving at least one first data component associated with a user and at least one second data component associated with the user; determining at least one first value for a first metric of the user based on the received at least one first data component; determining at least one second value for a second metric of the user based on the received at least one second data component; determining at least one third value for a third metric of the user based on the at least one first value of the first metric and the at least one second value of the second metric; and utilizing the at least one third value for the third metric in a forecasting mechanism.

Additional examples disclosed herein are directed to a system for automatic resource allocation forecasting and optimization comprising a memory configured to store computer executable instructions and a processor configured to interface with the memory and execute the computer executable instructions. The instructions, when executed, cause the processor to: receive at least one first data component associated with a user and at least one second data component associated with the user, determine at least one first value for a first metric of the user based on the received at least one first data component, determine at least one second value for a second metric of the user based on the received at least one second data component, determine at least one third value for a third metric of the user based on the at least one first value of the first metric and the at least one second value of the second metric, and utilize the at least one third value for the third metric in a forecasting mechanism.

Additional examples disclosed herein are directed to a tangible machine-readable medium comprising instructions for automatic resource allocation forecasting and optimization. The instructions, when executed, cause a machine to at least: receive at least one first data component associated with a user and at least one second data component associated with the user; determine at least one first value for a first metric of the user based on the received at least one first data component; determine at least one second value for a second metric of the user based on the received at least one second data component; determine at least one third value for a third metric of the user based on the at least one first value of the first metric and the at least one second value of the second metric; and utilize the at least one third value for the third metric in a forecasting mechanism.

As mentioned above, an organization is restricted to specific data sources and associated attributes (e.g., granularities) to forecast an allocation of these resources. This can be challenging because each organization has unique needs (e.g., data sources and associated attributes) that require evaluation in view of predetermined parameters (e.g., minimums, maximums, etc.) when forecasting an allocation of resources for operational purposes.

As such, a system is generally designed specific to an organization and developed based on organizational needs via customization efforts which can be time consuming and cost prohibitive (e.g., maintenance). For example, systems are often designed and developed via custom methodologies and algorithms that are programmatically maintained with each organizational change thereby requiring maintenance for every resource allocation iteration (e.g., on a quarterly basis). Accordingly, it would be highly beneficial to develop a system and method that can integrate and configure various unique data sources and associated attributes thereof to generate custom metrics based on specific organizational needs and apply these metrics in view of predetermined parameters to forecast and optimize an allocation of resources.

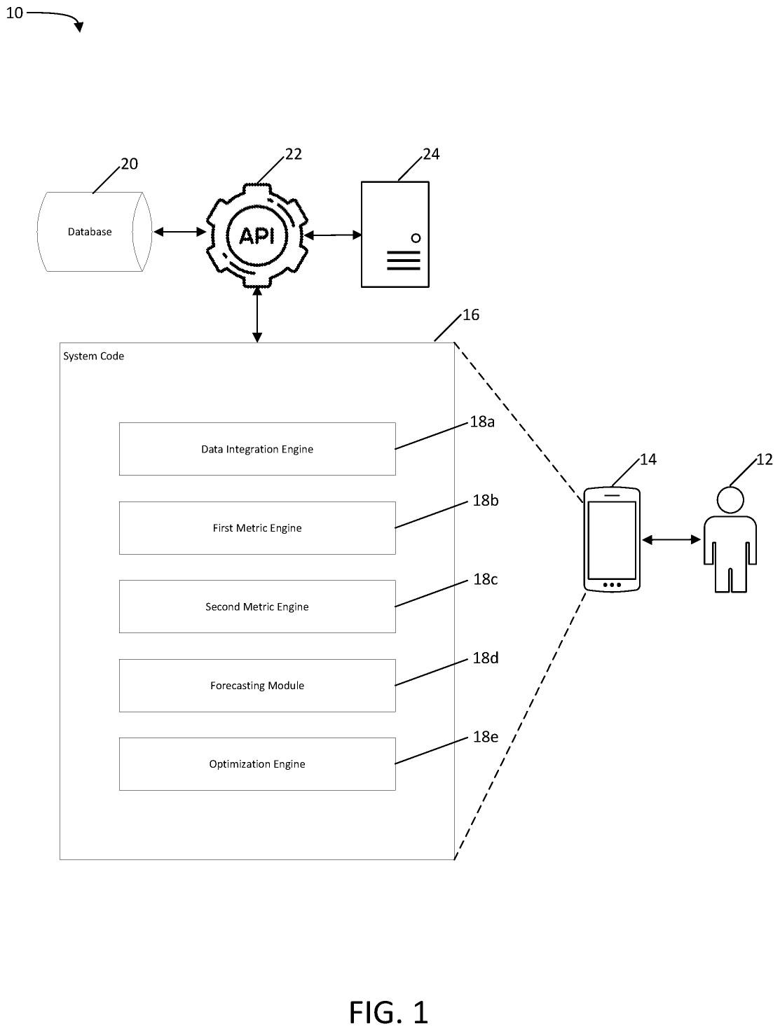

Turning to the drawings, FIG. 1 is a diagram illustrating an embodiment of the system 10 of the present disclosure. The system 10 can be embodied as a central processing unit 14 (processor) of a user 12 in communication with a database 20 and one or more central processing units 24 (e.g., external data sources) via an application programming interface 22 (API). The processors 14 and 24 could include, but are not limited to, a computer system, a server, a mobile computer, a cloud computing device, a smart phone, a tablet, a wearable, a scanner, a printer, or any other suitable device programmed to carry out the processes disclosed.

The system 10 can receive data from the device 14, the database 20 and/or the processor 24. Data sources can include, but are not limited to, internal data such as resource (e.g., labor) classification data, task classification data, executed task data, geolocation data, resource device (e.g., a mobile computer, a smart phone, a tablet, a wearable, a scanner, a printer, etc.) data, point of sale (POS) data, and modeled resource and task data and external data (e.g., third party data). The system 10 can receive internal data from a proprietary device (e.g., a device 14), module and/or system (e.g., a workforce management system, a human capital management system, etc.) interfacing with the system 10. The system 10 can receive external data (e.g., third party data) received from a third party (e.g., a vendor) non-proprietary system.

Each data source can have one or more associated attributes. An associated data attribute can be indicative of a granularity of a data source. For example, an associated data attribute can include, but is not limited to, one or more of a user definition, a classification, a time interval (e.g., a minute, hour, day, week, month, year, etc.), a time period, a facility type (e.g., a department, store, fulfilment center, etc.), and geolocation (e.g., a state, region, country, etc.). Additionally, a user 12 can set user defined data based on the received internal data and/or external data by integrating and configuring the received data and associated attributes.

The system 10 includes system code 16 (i.e., non-transitory, computer-readable instructions) stored on a computer-readable medium and executable by the hardware processor 14 or one or more computer systems. The processor 14 executes system code 16, which integrates and configures data sources and associated attributes thereof, generates custom metrics based on the integrated and configured data sources, and applies the custom metrics in view of predetermined parameters to automatically and dynamically forecast and optimize resource allocation.

The code 16 could include various custom-written software modules that carry out the steps/processes discussed herein including, but not limited to, a data integration engine 18a, a first metric engine 18b, a second metric engine 18c, a forecasting module 18d, and an optimization engine 18e. The data integration engine 18a can integrate and configure data points from different data source types via an API 22. For example, the data integration engine 18a can combine data points from different internal data sources and external third party (e.g., vendor) data sources. In another example, the data integration engine 18a can integrate and configure data points from a device 14 of a user 12 to determine at least one of an association, a derivation, and an annotation of one or more of the user 12, the device 14, and a facility.

The first metric engine 18b can receive at least one attribute (e.g., a data component or granularity) of at least one data source associated with a user 12 and can determine one or more measured values for a first metric measured value of a user based on the received at least one attribute. The one or more values can denote a resource (e.g., labor) allocation (e.g., cost) for a user 12. The second metric engine 18c can receive at least one attribute (e.g., a data component or granularity) of at least one data source associated with a user 12 and can determine one or more modeled values for a second metric modeled value of a user 12 based on the received at least one attribute. The one or more values can denote a modeled resource (e.g., labor) allocation (e.g., hours) for a user 12.

The forecasting module 18d can receive at least one value from among the measured values as a first metric measured value and receive at least one value from among the modeled values as a second metric modeled value. The forecasting module 18d can determine one or more values for a third metric forecasted value of a user 12 based on a received at least one measured value as a first metric measured value and a received at least one modeled value as a second metric modeled value. The determined one or more values can denote a total forecasted resource (e.g., labor) allocation (e.g., cost and hours) for a user 12. The optimization engine 18e can optimize resource allocation forecasting in view of predetermined parameters (e.g., minimums and maximums). The optimization engine 18e can apply these parameters across any data source type and associated attribute. The optimization engine 18e can also dynamically modify these predetermined parameters by increasing or decreasing the thresholds thereof to account for external factors and/or events.

As described in further detail below, the custom-written software modules can automatically leverage unique data sources and associated attributes thereof and parameters specific to an organization to forecast and optimize resource allocation. In this way, the system 10 realizes a non-conventional application of unique data sources and associated attributes thereof and parameters to automatically optimize processes executed by the processor 14 and increase the efficiency of each of the processes and the processor 14 (e.g., less computational resources required).

The code 16 could be programmed using any suitable programming languages including, but not limited to, C, C++, C#, Java or any other suitable language. Additionally, the code 16 could be distributed across multiple computer systems in communication with each other over a communications network, stored within hardware, and/or stored and executed on a cloud computing platform and remotely accessed by a computer system in communication with the cloud platform. The code 16 could communicate with the database 20 and the processor 24, which could be stored on the same computer system as the code 16, or on one or more other computer systems in communication with the code 16.

Still further, the system 10 could be embodied as a customized hardware component such as a field-programmable gate array (“FPGA”), application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

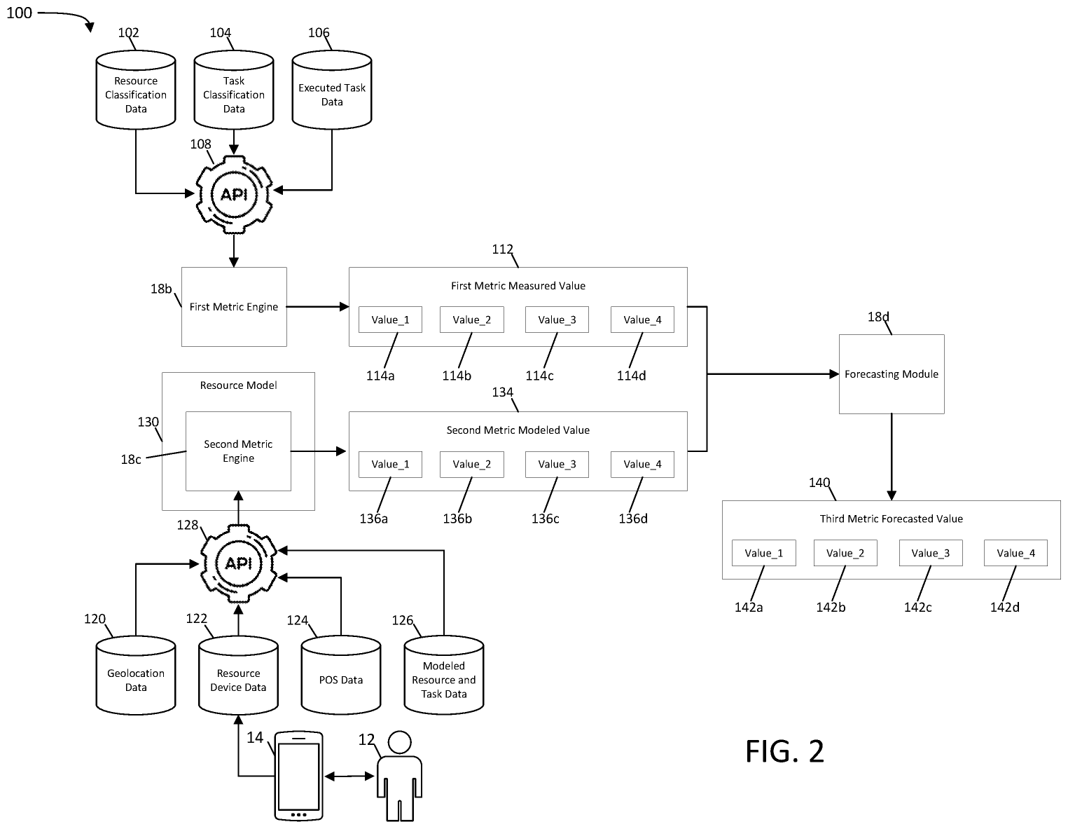

FIG. 2 is a diagram illustrating an embodiment of the system of the present disclosure. As shown in FIG. 2, the system 100 can comprise a first metric engine 18b, a resource model 130 having a second metric engine 18c, and a forecasting module 18d. The first metric engine 18b can receive data from a plurality of data sources including, but not limited to, resource (e.g., labor) classification data 102, task classification data 104, and executed task data 106 via an API 108. Each data source can have at least one associated attribute (e.g., data component or granularity). For example, the resource classification data 102 can be associated with a labor attribute including, but not limited to, status (full time or part-time), capability (e.g., able-bodied, handicapped, etc.), and wage classification (e.g., regular, overtime, special, and holiday). In another example, the task classification data 104 can be associated with a task attribute including, but not limited to, task performance intervals (e.g., daily, weekly, monthly) and classification (e.g., category and/or type). In yet another example, the executed task data 106 can be associated with an executed task attribute including, but not limited to, a task execution time period (e.g., hours) and the tasks executed. The executed task data 106 can be captured via at least one of an annotation, a voiced based logging mechanism and a biometric based logging mechanism.

Each of the resource classification data 102, the task classification data 104 and the executed task data 106 can be indicative of internal data received by the system 100 from a proprietary module and/or system (e.g., a workforce management system, a human capital management system, etc.) interfacing with the system 100 or external data (e.g., third party data) received from a third party (e.g., a vendor) non-proprietary system.

The first metric engine 18b can receive at least one attribute (e.g., a data component or granularity) of at least one data source associated with a user 12. For example, the first metric engine 18b can receive a regular wage classification data component and a task execution time period (e.g., hours) data component. The first metric engine 18b can determine one or more values 114a-d for a first metric measured value 112 of a user 12 based on the received at least one attribute. The one or more values 114a-d can denote a resource (e.g., labor) allocation (e.g., cost) for a user 12. For example, a first value 114a can denote a measured regular resource allocation cost for a user 12 given by Equation 1 below:

$$Measured Resource {Allocation}_{COST \_ REGULAR} = Resource {Classification}_{Wage \_ Regular} * Executed {Task}_{\_ Time Period} \qquad Equation 1$$

In another example, a second value 114b can denote an overtime resource allocation for a user 12. In another example, a third value 114c can denote a special resource allocation for a user 12. In yet another example, a fourth value 114d can denote a holiday resource allocation for a user. In this way, the values 114a-d are each indicative of a measured (e.g., captured) value based on a resource classification data wage type and a task execution time period. Alternatively or additionally, the system 100 can utilize a machine learning model to forecast a resource allocation for a user 12 based on historical data sources.

The second metric engine 18c can receive data from a plurality of data sources including, but not limited to, geolocation data 120, resource device data 122, point of sale (POS) data 124, and modeled resource and task data 126 via an API 128. Each data source can have at least one associated attribute (e.g., data component or granularity). For example, the geolocation data 120 can be associated with a facility attribute including, but not limited to, facility type (e.g., a department, store, fulfilment center, etc.), location (e.g., a county, state, region, country, etc.) and location rules and regulations (e.g., health and safety standards).

In another example, the resource device data 122 can be associated with a device 14 (e.g., a smart phone, a tablet, a wearable, a scanner, a printer, and a mobile computer) attribute including, but not limited to, an association (e.g., a device 14 identifier associated with a user 12, user 12 task data, and/or a facility, a device 14 location associated with task data, device 14 clock data associated with system clock data, and device 14 capabilities associated with task data), a derivation (e.g., task data derived from at least one application running on a device 14, device 14 utility and/or efficiency in relation to task data), and an annotation (e.g., a task annotation via a device 14 user interface such as a textual comment, voice data, and image data, and a task status annotation indicative of task data and task progress and/or state).

In another example, the POS data 124 can be associated with a volume (e.g., sales) driver attribute including, but not limited to, classification (e.g., item category and/or item), time period (e.g., morning, afternoon, evening), and frequency (e.g., daily, weekly, monthly). In yet another example, the modeled resource and task data 126 can be associated with a modeled attribute including, but not limited to, a modeled task execution time period (e.g., modeled hours), time period classification (e.g., regular, overtime, special, and holiday), and resource status (e.g., full time or part-time) for tasks to be executed.

Each of the geolocation data 120, resource device data 122, point of sale (POS) data 124, and modeled resource and task data 126 can be indicative of internal data received by the system 100 from a proprietary device 14, module and/or system (e.g., a workforce management system, a human capital management system, etc.) interfacing with the system 100 or external data (e.g., third party data) received from a third party (e.g., a vendor) non-proprietary system.

The second metric engine 18c can receive at least one attribute (e.g., a data component or granularity) of at least one data source associated with a user 12. For example, the second metric engine 18c can receive a modeled task execution time period (e.g., modeled hours) data component, a time period classification (e.g., regular, overtime, special, and holiday) data component, and a resource status (e.g., full time or part-time) data component. The second metric engine 18c can determine one or more values 136a-d for a second metric modeled value 134 of a user 12 based on the received at least one attribute. The one or more values 136a-d can denote a modeled resource (e.g., labor) allocation (e.g., hours) for a user 12. For example, a first value 136a can denote a regular resource allocation for a user 12. In another example, a second value 136b can denote an overtime resource allocation for a user 12. In another example, a third value 136c can denote a special resource allocation for a user 12. In yet another example, a fourth value 136d can denote a holiday resource allocation for a user. In this way, the values 136a-d are each indicative of a modeled value based on a modeled task execution time period, a time period classification, and a resource status.

The forecasting module 18d can receive at least one value from among the measured values 114a-d as a first metric measured value 112 and at least one value from among the modeled values 136a-d as a second metric modeled value 134. For example, the forecasting module 18d can receive a first value 114a for regular resource (e.g., labor) allocation (e.g., cost) and a first value 136a for regular resource (e.g., labor) allocation (e.g., hours).

The forecasting module 18d can determine one or more values 142a-d for a third metric forecasted value 140 of a user 12 based on the received at least one value from among the measured values 114a-d as a first metric measured value 112 and at least one value from among the modeled values 136a-d as a second metric modeled value 134. The one or more values 142a-d can denote a total forecasted resource (e.g., labor) allocation (e.g., cost and hours) for a user 12. For example, a first value 142a can denote a total forecasted regular resource allocation for a user 12 given by Equation 2 below:

$$Forecasted Resource {Allocation}_{REGULAR} = Measured Resource {Allocation}_{COST \_ REGULAR} / Modeled Resource {Allocation}_{HOURS \_ REGULAR} \qquad Equation 2$$

In another example, a second value 142b can denote a forecasted overtime resource allocation for a user 12. In another example, a third value 142c can denote a forecasted special resource allocation for a user 12. In yet another example, a fourth value 142d can denote a forecasted holiday resource allocation for a user 12. In this way, the values 142a-d are each indicative of a forecasted value based on a measured resource (e.g., labor) allocation (e.g., cost) and a modeled resource (e.g., labor) allocation (e.g., hours). As described in further detail below, the system 100 can utilize each of the values 142a-d in a forecasting mechanism to optimize resource allocation.

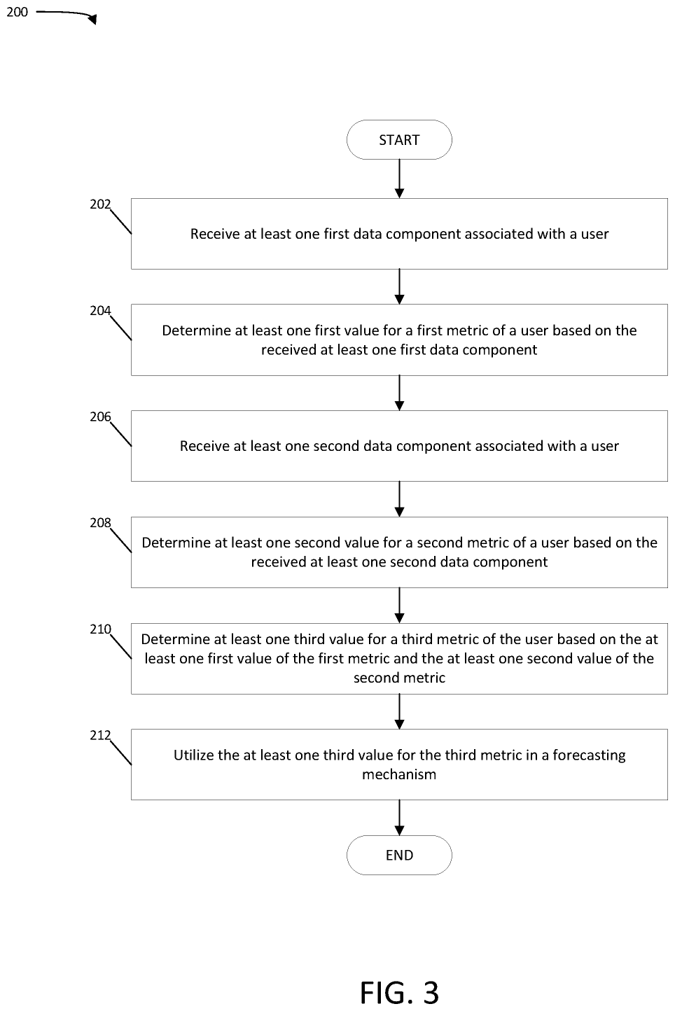

FIG. 3 is a flowchart illustrating processing steps 200 carried out by the system of the present disclosure. Beginning in step 202, the system receives at least one first data component associated with a user 12. In step 204, the system determines at lest one first value for a first metric of a user based on the received at least one first data component. Then, in step 206, the system receives at least one second data component associated with a user. In step 208, the system determines at least one second value for a second metric of a user based on the received at least one data component. In step 210, the system determines at least one third value for a third metric of the user based on the at least one first value of the first metric and the at least one second value of the second metric. In step 212, the system utilizes the at least on third value for the third metric in a forecasting mechanism.

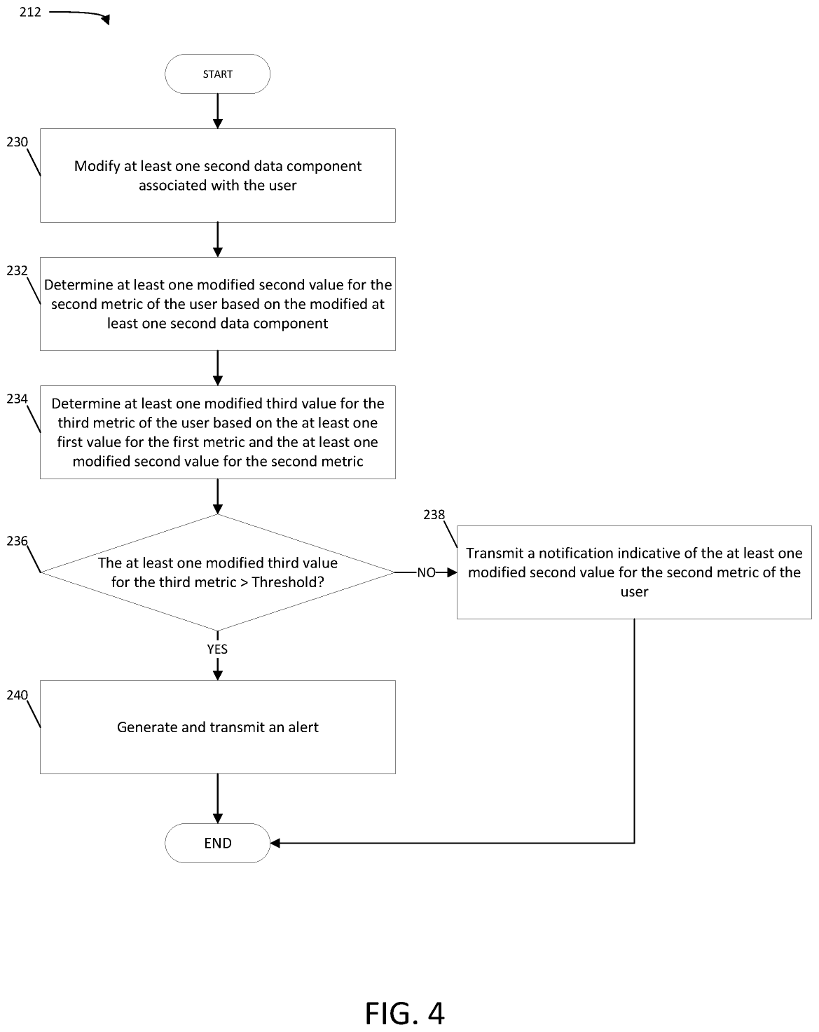

FIG. 4 is a flowchart illustrating step 212 of FIG. 3 in greater detail. Beginning in step 230, the system modifies at least one second data component associated with a user. In step, 232, the system determines at least one modified second value for the second metric of the user based on the modified at least one second data component. Then, in step 234, the system determines at least one modified third value for the third metric of the user based on the at least one first value of the first metric and the at least on modified second value of the second metric. In step 236, the system determines whether the at least one modified third value for the third metric is greater than a threshold (e.g., a predetermined resource allocation parameter). If the system determines that the at least one modified third value for the third metric is not greater than the threshold, then the system transmits a notification indicative of the at least one modified second value for the second metric of the user. If the system determines that the at least one modified third value for the third metric is greater than the threshold, then the system generates and transmits an alert.

As mentioned above, an organization is often restricted to specific data sources and associated attributes thereof to forecast an allocation of resources for operational purposes. This can be challenging because each organization has unique needs (e.g., data sources and associated attributes) that require evaluation in view of predetermined parameters when allocating these resources. As such, a system is generally designed specific to an organization and developed based on organizational needs via customization efforts which can be time consuming and cost prohibitive (e.g., maintenance).

The systems and methods of the present disclosure address these and other needs via a specific sequence of steps including, but not limited to, data integration and configuration, metric generation and application, and resource allocation forecasting and optimization. In particular, the system can integrate and configure internal and external data sources by combining and configuring data points thereof to generate custom metrics based on specific organizational needs.

Additionally, the system can apply these metrics in view of predetermined parameters to forecast and optimize an allocation of resources. In this way, the system realizes a non-conventional application of unique data sources and associated attributes thereof and customized metrics to automatically optimize processes executed by a processor of the system and increase the efficiency of each of the processes (e.g., decreased system maintenance) and the processor (e.g., decreased computational resources).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method for automatic resource allocation and optimization, comprising:
receiving at least one first data component associated with a user and at least one second data component associated with the user;
determining at least one first value for a first metric of the user based on the received at least one first data component;
determining at least one second value for a second metric of the user based on the received at least one second data component;
determining at least one third value for a third metric of the user based on the at least one first value of the first metric and the at least one second value of the second metric; and
utilizing the at least one third value for the third metric in a forecasting mechanism.

2. The method of claim 1, wherein
the first value for the first metric is indicative of a measured cost of the user to execute a task,
the second value for the second metric is indicative of a modeled time period for the user to execute the task, and
the third value for the third metric is indicative of a forecasted cost of the user to execute the task during the modeled time period.

3. The method of claim 1, wherein utilizing the at least one third value for the third metric in a forecasting mechanism comprises:
modifying the at least one second data component associated with the user;
determining at least one modified second value for the second metric of the user based on the modified at least one second data component;
determining at least one modified third value for a third metric of the user based on the at least one first value for the first metric and the at least one modified second value for the second metric; and
determining whether the at least one modified third value for the third metric exceeds a threshold.

4. The method of claim 1, wherein
in response determining the at least one modified third value for the third metric exceeds the threshold, generating and transmitting an alert, and
in response determining the at least one modified third value for the third metric does not exceed the threshold, generating and transmitting a notification indicative of the at least one modified second value for the second metric of the user.

5. The method of claim 1, wherein the received the at least one second data component is associated with a device of the user.

6. A system for automatic resource allocation forecasting and optimization comprising:
a memory configured to store computer executable instructions; and
a processor configured to interface with the memory and execute the computer executable instructions to cause the processor to:
receive at least one first data component associated with a user and at least one second data component associated with the user,
determine at least one first value for a first metric of the user based on the received at least one first data component,
determine at least one second value for a second metric of the user based on the received at least one second data component,
determine at least one third value for a third metric of the user based on the at least one first value of the first metric and the at least one second value of the second metric, and
utilize the at least one third value for the third metric in a forecasting mechanism.

7. The system of claim 6, wherein
the first value for the first metric is indicative of a measured cost of the user to execute a task,
the second value for the second metric is indicative of a modeled time period for the user to execute the task, and
the third value for the third metric is indicative of a forecasted cost of the user to execute the task during the modeled time period.

8. The system of claim 6, wherein the processor is configured to utilize the at least one third value for the third metric in a forecasting mechanism by:
modifying the at least one second data component associated with the user,
determining at least one modified second value for the second metric of the user based on the modified at least one second data component,
determining at least one modified third value for a third metric of the user based on the at least one first value for the first metric and the at least one modified second value for the second metric, and
determining whether the at least one modified third value for the third metric exceeds a threshold.

9. The system of claim 8, wherein the processor is further configured to:
in response determining the at least one modified third value for the third metric exceeds the threshold, generate and transmit an alert, and
in response determining the at least one modified third value for the third metric does not exceed the threshold, generate and transmit a notification indicative of the at least one modified second value for the second metric of the user.

10. The system of claim 6, wherein the received the at least one second data component is associated with a device of the user.

11. A tangible machine-readable medium comprising instructions for automatic resource allocation forecasting and optimization that, when executed, cause a machine to at least:
receive at least one first data component associated with a user and at least one second data component associated with the user;
determine at least one first value for a first metric of the user based on the received at least one first data component;
determine at least one second value for a second metric of the user based on the received at least one second data component;
determine at least one third value for a third metric of the user based on the at least one first value of the first metric and the at least one second value of the second metric; and
utilize the at least one third value for the third metric in a forecasting mechanism.

12. The tangible machine-readable medium of claim 11, wherein
the first value for the first metric is indicative of a measured cost of the user to execute a task,
the second value for the second metric is indicative of a modeled time period for the user to execute the task, and
the third value for the third metric is indicative of a forecasted cost of the user to execute the task during the modeled time period.

13. The tangible machine-readable medium of claim 11, wherein the instructions, when executed, further cause the machine to utilize the at least one third value for the third metric in a forecasting mechanism by:
modifying the at least one second data component associated with the user;
determining at least one modified second value for the second metric of the user based on the modified at least one second data component;
determining at least one modified third value for a third metric of the user based on the at least one first value for the first metric and the at least one modified second value for the second metric; and
determining whether the at least one modified third value for the third metric exceeds a threshold.

14. The tangible machine-readable medium of claim 13, wherein the instructions, when executed, further cause the machine to:
in response determining the at least one modified third value for the third metric exceeds the threshold, generate and transmit an alert, and
in response determining the at least one modified third value for the third metric does not exceed the threshold, generate and transmit a notification indicative of the at least one modified second value for the second metric of the user.

15. The tangible machine-readable medium of claim 11, wherein the received the at least one second data component is associated with a device of the user.
